(19) United States
(12) Patent Application Publication
(10) Pub. No.: US 2017/0337787 A1
(43) Pub. Date: Nov. 23, 2017

(54) HVAC TROUBLESHOOTING TOOL

(71) Applicant: Ralston Bryce, Brooklyn, NY (US)

(72) Inventor: Ralston Bryce, Brooklyn, NY (US)

(21) Appl. No.: 15/436,351

(22) Filed: Feb. 17, 2017

Related U.S. Application Data
(60) Provisional application No. 62/340,064, filed on May 23, 2016.

(51) Int. Cl. G08B 5/36; F24F 11/00; G08B 21/18

(52) U.S. Cl. CPC G08B 5/36; G08B 21/182; F24F 11/0086; F24F 2011/0091

(57) ABSTRACT

An HVAC testing system which includes an HVAC maintenance tool with a pinned input/output connector, logic circuitry, and a sensor-and-lead-cable having two wires. Each of the two wires have a first end and a second end. The first ends of the two wires are separately electrically engaged in a single pinned connector complementary to the pinned input/output connector, and the second ends are each attached to a separate conducting clip.

### CROSS-REFERENCE TO RELATED APPLICATION

The present application is related to and claims priority to U.S. Provisional Patent Application No. 62/340,064 filed May 23, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of heating, ventilation and air conditioning (“HVAC”) maintenance and more specifically relates to tools for facilitating the troubleshooting of HVAC systems.

### 2. Description of Related Art

HVAC technicians often need to test the operational performance of HVAC systems. Technicians typically find it necessary to make multiple trips from a thermostat to distant or dispersed HVAC equipment. This movement takes an extensive amount of time available to the technician. Further, having to wait for the thermostat to turn on the equipment and cycle the different stages of operations can be frustrating. Further, some troubleshooting may require more than one person to check equipment. A suitable solution is desired.

U.S. Pat. Pub. No. 2013/0338836 to Vaughn relates to an automated hvac system functionality test. The described automated HVAC system functionality test includes systems and methods for performing automated functionality testing for a HVAC system. A method disclosed therein includes receiving a user input to test one of a heating or cooling functionality of the HVAC system. The method also includes identifying an amount to change a set point for a zone controller for the HVAC system based on the user input. The method further includes changing the set point for the zone controller to force the HVAC system into one of a heating mode and a cooling mode in accordance with the user input. Additionally, the method includes storing data from the HVAC system operating in the one of the heating mode and the cooling mode.

### BRIEF SUMMARY OF THE INVENTION

In view of the foregoing disadvantages inherent in the known HVAC maintenance art, the present disclosure provides a novel HVAC maintenance system and method. The general purpose of the present disclosure, which will be described subsequently in greater detail, is to provide an HVAC maintenance tool.

An HVAC maintenance tool is disclosed herein. The HVAC maintenance tool includes a form factor having a surface and defining an enclosed volume. The volume contains circuity including a first series circuit comprising, in the following order, a power input, a power indicator light, a first switch, a second switch, a third switch, a second indicator light, and a first power output. The volume also contains a second series circuit comprising, in the following order, a fourth switch, a third indicator light, and a second power output, wherein the second series circuit is connected in parallel with the first series circuit at a point between the first switch and the second switch.

According to another embodiment, an HVAC testing system is also disclosed herein. The HVAC testing system includes an HVAC maintenance tool with a pinned input/output connector, logic circuitry, and a sensor-and-lead-cable comprising two wires. Each of the two wires has a first end and a second end. The first ends of the two wires are separately electrically engaged in a single pinned connector complementary to the pinned input/output connector, and the second ends are each attached to a separate conducting clip.

According to another embodiment, a method for the local testing of an HVAC system is also disclosed herein. The method includes accessing the electric terminals of HVAC components of an HVAC system, connecting the electric terminals of the HVAC components to an electronic enclosure logic circuitry, providing power to the logic circuitry from the HVAC system by closing a power switch mounted on or in the electronic enclosure. The method further includes energizing a specific HVAC component(s) by closing a designated switch(es) on the electronic enclosure that shuts a power relay/switch/breaker of the HVAC component and measuring the temperature of an airflow created by energizing the specific HVAC component using a temperature probe functionally connected to the electronic enclosure into the airflow.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, an HVAC maintenance tool, constructed and operative according to the teachings of the present disclosure.

FIG. 1 is an external plan view of the HVAC maintenance tool, according to an embodiment of the disclosure.

FIG. 2 is a perspective view of the HVAC maintenance tool of FIG. 1 with its accoutrements, according to an embodiment of the present disclosure.

FIG. 3 is a wiring schematic of the HVAC maintenance tool of FIG. 1, according to an embodiment of the present disclosure.

FIG. 4 is a functional view of the HVAC maintenance tool of FIG. 1 connected to an HVAC system, according to an embodiment of the present disclosure.

FIG. 5 is a flow diagram illustrating the use of the HVAC maintenance tool, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to HVAC maintenance and more particularly to an HVAC maintenance tool as used to facilitate the local testing of an HVAC system. The operation of HVAC systems are known in the art. In the interest of brevity and clarity any discussion of heating and air conditioning system operation and their various heating and cooling stages is mere surplusage and is not described herein.

Generally, most buildings use HVAC systems. The subject matter disclosed herein provides HVAC maintenance technicians with a hand tool capable of being connected locally to an HVAC system in order to speed up repairs and improve performance control. The HVAC maintenance tool includes a number of dedicated on/off switches related to a fan, primary heating and cooling mechanisms, temperature control, and secondary heating and cooling mechanisms of the HVAC system. The device allows the technician to turn on the individual components of HVAC equipment locally in order to read temperatures conveniently and in isolation thereby determining if the equipment is operating correctly. The HVAC maintenance tool includes a strap with a magnetic pad on one end in order to hang the HVAC maintenance from various convenient ferrous objects or surfaces.

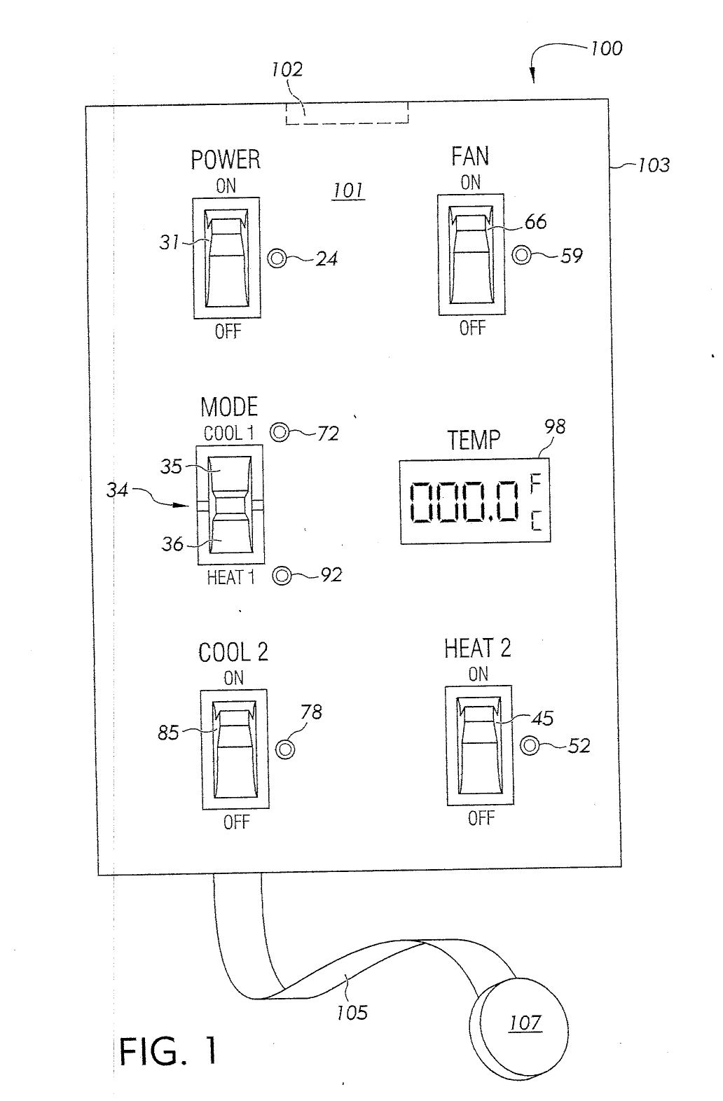

Referring now more specifically to the drawings by numerals of reference, there is shown in FIGS. 1-4 various views of a HVAC maintenance tool 100. FIG. 1 shows an electronics enclosure 101 of the HVAC maintenance tool 100, according to an embodiment of the present disclosure.

The electronics enclosure 101 is any suitably sized and shaped container, or a case, defining a volume in which to secure and contain electrical and electronic devices of the HVAC maintenance tool 100. As a non-limiting example, the electronic enclosure 101 is described herein to be a box, but may take any suitable or convenient shape such as a sphere, a pyramid, or an irregular, ergonomically shaped casing.

The electronic enclosure 101 has an outer surface including a cover 103 with cutouts into which switches, lights, a temperature indicator 98, or other actuator or indicator may be accommodated or mounted. In the exemplary, non-limiting embodiment of FIG. 1, the cover 103 accommodates five (5) dual position switches. However, that number may be more or fewer to accommodate the desired functionality of the HVAC maintenance tool and may be any type of dual position switch such as a toggle switch, a knife switch, a rocker switch and the like. The exemplary cover 103 also accommodates six (6) indicator lights, and temperature indicator 98.

Specifically, the exemplary electronic enclosure 101 accommodates a power on/off switch 31 and a power indicator light 24. The other switches include a fan on/off switch 66, a cooling stage/heating stage bi-position switch 34, a second stage cooling on/off switch 85, and a second stage heating on/off switch 45. Other lights include a fan on/off indicator light 59, a first cooling stage indicator light 72, a first stage heating indictor light 92, a second stage heating stage indicator light 52, and a second stage cooling indicator light 78.

The cooling stage/heating stage bi-position switch 34 has a current input and two current outputs (C1, H1). A first switch output C1 provides power to the first and second cooling stages of the HVAC system 130. A second switch output H1 provides power to the first and second heating stages of the HVAC system 130.

The electronic enclosure 101 may also include a magnetic suspension device 106. As a non-limiting example, the magnetic suspension device 106 may comprise a flexible strap 105 affixed to the electronic enclosure 101 at a first end and affixed to a magnetic end piece 107 at its second end. The magnetic end piece 107 may be used to magnetically attach the electronics enclosure 101 to a metal surface such as an HVAC system housing (not shown).

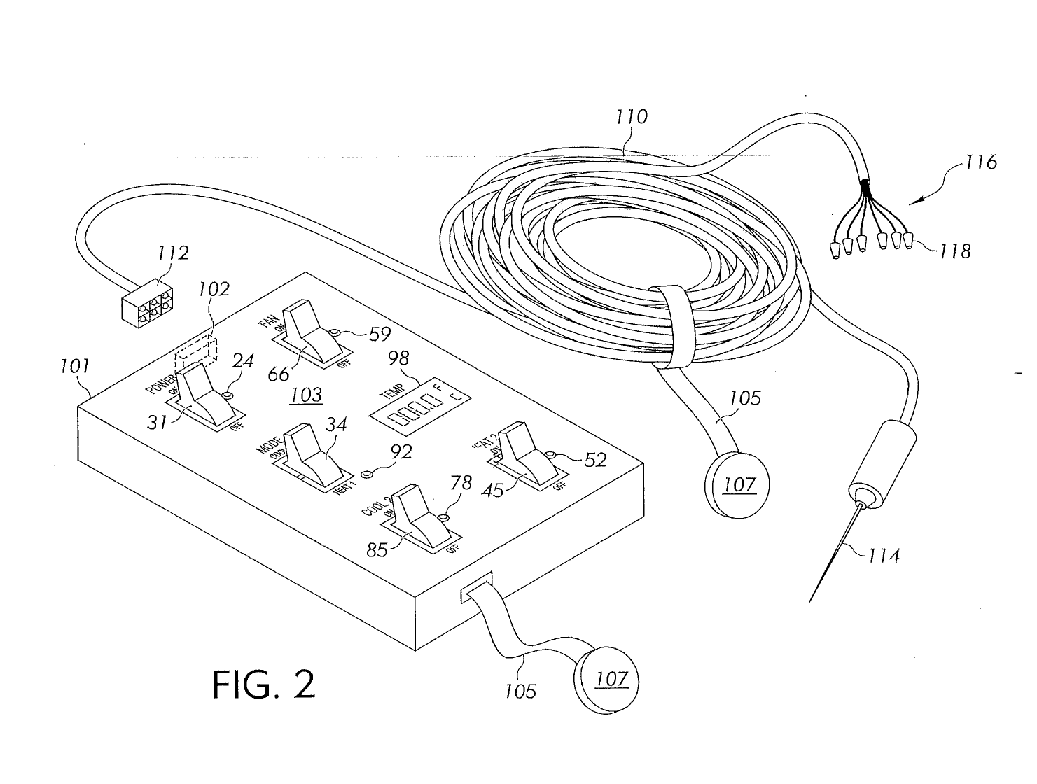

FIG. 2 depicts the electronic enclosure 101 of FIG. 1 along with its exemplary sensor and lead cable 110 according to an embodiment of the present disclosure. The exemplary, mom-limiting sensor and lead cable 110 depicted in FIG. 2 comprises eight wires (together 116) each with a first end and a second end. The first end of each wire 116 is connected to one of a male or female pin connector 112 that complements the opposite eight pin connector socket 102 in the electronics enclosure 101. The second end of each wire 116 of the exemplary sensor and lead cable 110 of FIG. 2 terminates with one of an electrically conducting clip (together 118) or a temperature probe 114.

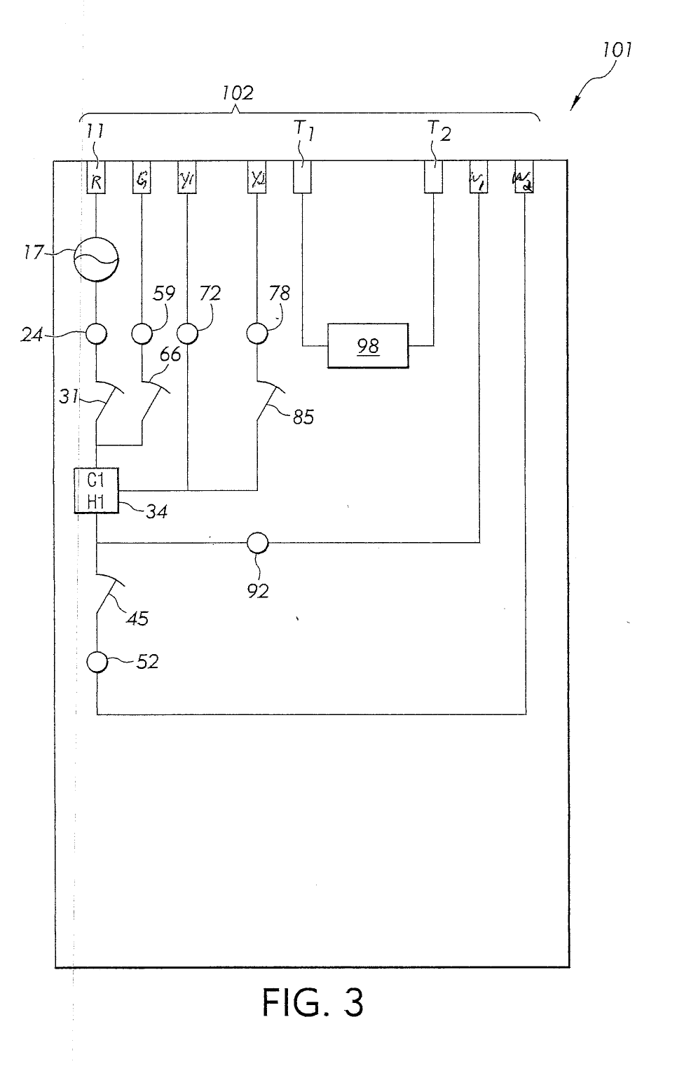

FIG. 3 is a wiring schematic of the exemplary electronics enclosure 101 of FIG. 1, according to an exemplary embodiment of the present disclosure. The exemplary electronics enclosure 101, includes a multi-pin electrical connector 102. In the embodiment of FIG. 3, there are an equal number of pins 11 to accommodate each of the wires connecting through connector 112, although this does not necessarily need to be the case. It is contemplated that a fewer number of wires 116 and corresponding pins 11 may be used with a resulting reduction in functionality.

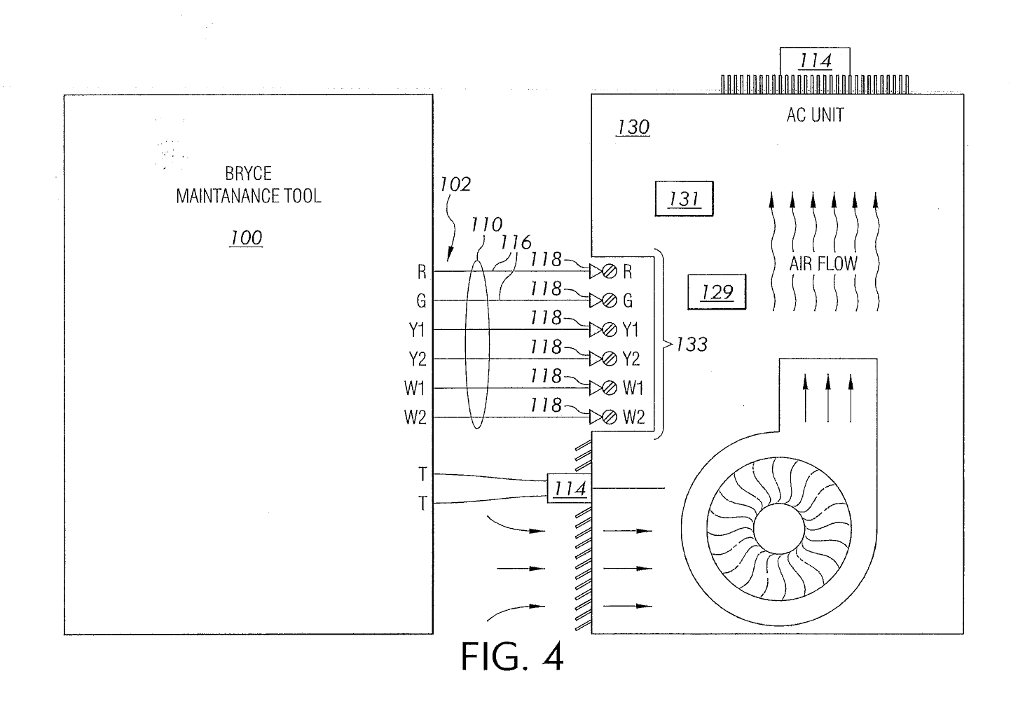

In FIG. 3, pin R is a power input that receives DC power from a DC power source 131 in the AC unit being tested (See, FIG. 4). The DC power passes through fuse 17 and power indicator light 24 that are connected in series.

When closed, power switch 31 allows current to pass through the cooling stage/heating stage bi-position switch 34, which is either in the first stage cooling position 35 or the first stage heating position 36 (See, FIG. 1). When in the first stage cooling position 35, current is passed through the first stage cooling indicator light 72 and back to a relay or breaker 129 in the HVAC system 130 (see FIG. 4) that starts the first stage cooler (not shown) in the HVAC system 130 being tested. In this configuration the power light 24 and the first stage cooling light 72 are lit. Alternatively, when in the first stage heating position 36, current is passed through the first stage heating light 92 and to a relay/breaker 129 that starts the first stage heater (not shown) in the HVAC system 130 being tested. In this configuration the power light 24 and the first stage heating indicator light 92 are lit. In either case the temperature probe 114 may be used to measure air flow temperature in order to determine the proper operation of the first stage cooler or the first stage heater (not shown).

In the interest of clarity and brevity, the various combinations and permutations of exemplary switches, and their resulting effects, are presented in Table 1 below:

TABLE 1

| SWITCHES | | | | | |
|---|---|---|---|---|---|
| 31 | 34 | 45 | 66 | 85 | Resulting Conditions |
| Closed | C1 | Disabled | Open | Open | Lights 24, 72 light and HVAC stage 1 cooling |
| | | | | | starts |
| Closed | C1 | Disabled | Closed | Open | Lights 24, 59 and 72 light. Fan starts and |
| | | | | | HVAC stage 1 cooling starts. |
| Closed | C1 | Disabled | Open | Closed | Lights 24, 72 and 78 light. HVAC stage 1 |
| | | | | | cooling and stage 2 cooling starts. |
| Closed | C1 | Disabled | Closed | Closed | Lights 24, 59, 72 and 78 light. Fan starts, |
| | | | | | HVAC stage 1 cooling starts and stage 2 |
| | | | | | cooling starts. |
| Closed | H1 | Open | Open | Disabled | Light 92 lights and HVAC stage 1 heating |
| | | | | | starts. |
| Closed | H1 | Closed | Open | Disabled | Lights 52 and 92 light. HVAC stage 1 and |
| | | | | | stage 2 heating start. |
| Closed | H1 | Open | Closed | Disabled | Lights 59 and 92 light. The HVAC fan and |
| | | | | | stage 1 cooling start. |
| Closed | H1 | Closed | Closed | Disabled | Lights 52, 59 and 92 light. The HVAC fan, |
| | | | | | stage 1 and stage 2 heating start. |

FIG. 4 is an abstract bloc diagram according to an embodiment of the present disclosure depicting the connection of sensor and lead cable 110 of the HVAC maintenance tool 100 to an HVAC system 130. For the sake of explanation, the wires 116 of the sensor and lead cable 110 will be referred to as wires R, G, Y1, Y2, W1, W2, T1 and T2 that correspond to the specific electric terminals 133 on HVAC system 130.

In this example, wire R is connected from a voltage output of a step down transformer 131 in the HVAC system 130 and delivers 24v DC power to the power input pin 11 of the HVAC maintenance tool 100. The exemplary 24v DC power is then selectively distributed to other terminals (G, Y1, Y2, W1, W2) of the HVAC system 130 through the circuitry of the HVAC maintenance tool 100 (See FIG. 3).

In this exemplary e G is the input voltage to a breaker/solenoid connecting the HVAC fan 134, Y1 is the input voltage of the first stage HVAC compressor breaker/solenoid/relay (not shown), Y2 is the input voltage of the second stage HVAC compressor breaker/solenoid/relay (not shown), W1 is the input voltage o the first stage HVAC heater breaker/solenoid/relay (not shown), and W2 is the input voltage o the second stage HVAC heater breaker/solenoid/relay (not shown). For the sake of clarity, the various breaker/solenoids/relays of the HVAC system 130 that are referenced herein are represented by a single item 129.

Wires T1 and T2 are the input and output leads between the temperature probe. 114 and the temperature indicator 98. Any suitable temperature probe and indictor may be used. Although not shown, the HVAC maintenance tool 100 may include additional circuitry tapping current from a location inside the electronic enclosure 101 to provide power to the temperature indicator 98. Such a location may be at ar power switch 31.

As a non-limiting operational example, when the power switch 31 and the fan on/off switch 66 are shut, 24v power is delivered to the breaker or solenoid switch in the HVAC system 130 that energizes the HVAC fan 134. By manipulating the various other switches, a technician may control the various components at e HVAC system 130 without having to take time to move to a distant thermostatelsewhere to turn on the various components of the HVAC system 130.

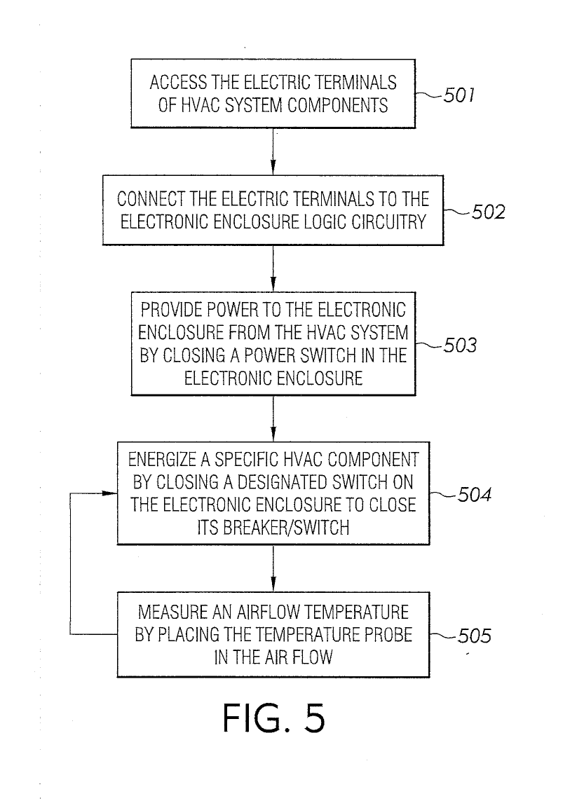

FIG. 5 is a flow diagram illustrating a method 500 for testing an HVAC system 130 according to an embodiment of the present disclosure. In particular, the method 500 may use one or more components or features of the HVAC maintenance tool 100 as described above. As illustrated, the method 500 may include physically accessing the electric terminals 133 of the various components of the HVAC system 130 at process 502, including a power source 131. At process 504, each electric terminal 133 is connected to a pin (R, G, Y1, Y2, W1, W2) of the electronic enclosure 101 via a wire 116 of the sensor and lead cable 110. Power may then be provided to the electronic enclosure 101 by shutting the power switch 31 of the electronic enclosure 101 at process 506. A maintenance technician may then energize one or more components of the HVAC system 130 to be tested by changing the position of one or more switches provided on the electronics enclosure 101 at process 508. Once an airflow has been established by energizing one or more components of the HVAC system 130, component performance may be evaluated by at least placing the temperature probe 114 in an air flow path generated by the HVAC component at process 510. Processes 508 and 510 may be repeated as required.

The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for the HVAC MAINTENANCE TOOL (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A heating, ventilation and air conditioning (HVAC) tool, comprising:
a form factor having a surface and defining an enclosed volume, the volume containing circuity including:
a first series circuit comprising, and attached in the following order,
a power input,
a power indicator light,
a first switch,
a second switch,
a third switch,
a second indicator light, and
a first power output; and
a second series circuit comprising, attached in the following order,
a fourth switch
a third indicator light, and
a second power output,
wherein the second series circuit is connected in parallel with the first series circuit between the first switch and the second switch.

2. The ventilation and air conditioning (HVAC) tool of claim 1, further including a third series circuit comprising, and attached in the following order,
a fifth switch,
fourth indicator light, and
a third power output,
wherein the third series circuit is connected to an output of the second switch and is connected in parallel with the first series circuit and the second series circuit.

3. The ventilation and air conditioning (HVAC) tool of claim 1, further including a fourth series circuit comprising, and attached in the following order,
a fifth indicator light, and
a fourth power output,
wherein the fourth series circuit is connected to a first output of the second switch and is connected in parallel with the first series circuit and the second series circuit.

4. The ventilation and air conditioning (HVAC) tool of claim 1, further including a fifth series circuit comprising, and attached in the following order,
a sixth indicator light, and
a fifth power output,
wherein the fifth series circuit is connected to a second output of the second switch and is connected in parallel with the first series circuit and the second series circuit.

5. The ventilation and air conditioning (HVAC) tool of claim 1, further including a temperature indicator connected in series to an electronic input pin and an electronic output pin.

6. A HVAC testing system, comprising:
a HVAC maintenance tool with a pinned input/output connector,
logic circuitry, and
a sensor-and-lead-cable comprising at least two wires, each with a first end and a second end,
wherein the first ends of the at least two wires are separately engaged in a second pinned connector that is complementary to the pinned input/output connector and the second ends of the wires are each attached to a separate conducting clip.

7. The HVAC testing system of claim 6, wherein a first of the two wires carries a voltage input and the second of the two wires is a voltage output configured to energize a device external to the HVAC testing system.

8. The HVAC testing system of claim 6, wherein the logic circuitry of the HVAC maintenance tool includes a bi-position switch with an input and two outputs.

9. The HVAC testing system of claim 8, wherein the logic circuitry comprises five series circuits connected in parallel relative to each other, each of the five parallel series circuits terminating at the pinned input/output connector at a first end and the bi-position switch at a second end.

10. The HVAC testing system of claim 6, further comprising a temperature indicator electrically connected to the pinned input/output connector.

11. The HVAC testing system of claim 9, wherein the logic circuitry includes five indicator lights, one indicator light of the five indicator lights being connected into each of the five series circuits.

12. The HVAC testing system of claim 6, wherein the electronics enclosure includes a flexible strap with a magnetic end piece.

13. A method for local testing of an HVAC system, comprising:
accessing electric terminals of one or more HVAC system components;
connecting the electric terminals of the one or more HVAC system components to logic circuitry arrayed in an electronic enclosure;
providing power to the electronic enclosure logic circuitry from the HVAC system by closing a power switch in the electronic enclosure logic circuitry;
energizing at least one of the HVAC system components by closing a designated switch on the electronic enclosure logic circuitry that provides a voltage that shuts a power relay/switch of the at least one HVAC system components; and
measuring the temperature of an airflow created by the energizing of the at least one HVAC components by placing a temperature probe that is functionally connected to the electronic enclosure into the airflow.
